(19) United States
(12) Patent Application Publication
(10) Pub. No.: US 2024/0399658 A1
(43) Pub. Date: Dec. 5, 2024

(54) THREE-DIMENSIONAL PRINTER WITH CHANGEABLE NOZZLES

(71) Applicant: ARIEL SCIENTIFIC INNOVATIONS LTD., Ariel (IL)

(72) Inventors: Nir SHVALB, Ariel (IL); Oded MEDINA, Ariel (IL); Shlomi HACOHEN, Ariel (IL)

(21) Appl. No.: 18/700,266

(22) PCT Filed: Oct. 13, 2022
(86) PCT No.: PCT/IL2022/051087

§ 371 Date: Apr. 10, 2024

Related U.S. Application Data
(60) Provisional application No. 63/255,495, filed on Oct. 14, 2021.

(51) Int. Cl. B29C 64/209; B29C 64/118; B29C 64/25; B33Y 10/00; B33Y 30/00

(52) U.S. Cl. CPC B29C 64/209; B29C 64/118; B29C 64/25; B33Y 10/00; B33Y 30/00

(57) ABSTRACT

A three-dimensional printer comprising: a printing head that includes a heater for fusing a material; a plurality of nozzles, each nozzle including an opening through which the material that is fused by the heater is extrudable; and a mechanism for causing the fused material to be extruded solely through the opening of a selected nozzle of the plurality of nozzles.

### CROSS REFERENCE TO RELATED APPLICATIONS

This application claims the benefit of priority of U.S. Provisional Application No. 63/255,495, titled “THREE-DIMENSIONAL PRINTER WITH CHANGEABLE NOZZLES”, filed Oct. 14, 2021, the contents of which are incorporated herein by reference in their entirety.

### FIELD OF THE INVENTION

The present invention relates to three-dimensional printing. More particularly, the present invention relates to a three-dimensional printer with changeable nozzles.

### BACKGROUND OF THE INVENTION

Three-dimensional printing, also referred to as additive manufacturing, is often used to manufacture a three-dimensional object based on digitally input instructions. For example, the instructions may be produced by a program for computer-aided design. A large variety of three-dimensional printers are commercially available, ranging from industrial printers, printers that print colored objects, to relatively low cost home printers. In addition to the primary application in prototype modeling, in recent years three-dimensional printers have been applied in limited production of parts for use in various industries, including transportation and aviation, fashion, medicine, and others.

Various techniques are applied in different types of three-dimensional printers. For example, a liquid polymer or a polymeric, metallic, or ceramic powder may be deposited in layers on a base, where portions of each layer that are to form part of a printed object are hardened by curing or fusion (e.g., by exposure to a suitable laser). In some three-dimensional printers, small quantities of a melted material (typically a polymer) are sequentially deposited to form layers of the printed object, after which the material hardens (e.g., due to cooling).

In a common three-dimensional printing technique known as fused deposition modeling (FDM), the material is delivered to a printing head in the form of a wire made of a plastic or other polymer. At the printing head, the outermost end of the wire is heated by a heated injection head that produces a thin stream of the material that is extruded to form a portion of the object. For example, a model of the object may be constructed in accordance with a Cartesian or other coordinate system. The printing head may be directed sequentially to each point of the coordinate system at which the material is to be deposited. Such a printer may be configured to move the printing head along a fixed Cartesian grid (e.g., a printing head configured to move along a rod, with the rod translatable being laterally translatable), or may utilize delta robot technology to move the printing head to a desired coordinate.

In some examples of FDM three-dimensional printers, multiple nozzles may be used to extrude different materials onto the model. For example, different nozzles may deposit differently colored polymers. In some cases, a thickness of a layer of deposited material may be varied for different layers.

The foregoing examples of the related art and limitations related therewith are intended to be illustrative and not exclusive. Other limitations of the related art will become apparent to those of skill in the art upon a reading of the specification and a study of the figures.

### SUMMARY OF THE INVENTION

The following embodiments and aspects thereof are described and illustrated in conjunction with systems, tools and methods which are meant to be exemplary and illustrative, not limiting in scope.

There is provided, in an embodiment, a three-dimensional printer comprising: a printing head that includes a heater for fusing a material; a plurality of nozzles, each nozzle including an opening through which the material that is fused by the heater is extrudable; and a mechanism for causing the fused material to be extruded solely through the opening of a selected nozzle of the plurality of nozzles.

In some embodiments, the opening of a nozzle of the plurality of nozzles differs in size or shape from the opening of another nozzle of the plurality of nozzles.

In some embodiments, the selected nozzle is attachable to the printing head to enable extrusion of the fused material through the opening of the selected nozzle, and is detachable from the printing head after the extrusion through the selected nozzle.

In some embodiments, the printer comprises a storage region in which the plurality of nozzles are storable.

In some embodiments, the mechanism comprises a moving mechanism to move the printing head to a storage location of the selected nozzle within the storage region to attach the selected nozzle to the printing head.

In some embodiments, the moving mechanism is further configured to move the printing head to a vacant storage location within the storage region to store a currently attached nozzle after detachment from the printing head.

In some embodiments, the plurality of nozzles are mounted on a ring that is rotatable to bring the selected nozzle to the heater to enable extrusion of the fused material through the opening of the selected nozzle.

In some embodiments, the mechanism is configured to rotate the ring.

In some embodiments, the plurality of nozzles are mounted on a plate that is movable to bring the selected nozzle to the heater to enable extrusion of the fused material through the opening of the selected nozzle.

In some embodiments, the mechanism is configured to rotate or translate the plate.

In some embodiments, the printing head further comprises a reservoir of the fused material to which the plurality of nozzles are attached, wherein each of the nozzles includes a stopper.

In some embodiments, the mechanism is configured to open the stopper of the selected nozzle, while closing the stopper of all other nozzles of the plurality of nozzles.

In some embodiments, the printer comprises a controller that is configured to operate the mechanism in accordance with a previously generated printing plan.

There is also provided, in an embodiment, a method for generating a printing plan for operation of a three-dimensional printer to print a three-dimensional object, the method comprising: receiving a description of the object; calculating a sequence of actions to be performed by the printer that optimizes printing of the object, the actions including at least: selecting a nozzle of a plurality of nozzles; and extruding material that is fused by a heater of the printing head through the selected nozzle to print a part of the object.

In some embodiments, optimizing of said printing plan comprises at least one of: minimizing a printing time, minimizing material usage, achieving a required material strength of the object, and achieving a required surface property of the object.

In addition to the exemplary aspects and embodiments described above, further aspects and embodiments will become apparent by reference to the figures and by study of the following detailed description.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 schematically illustrates a three-dimensional printer with changeable nozzles, according to some embodiments;

FIG. 2 schematically illustrates an example of a printing head with selectable nozzles, according to some embodiments;

FIG. 3 schematically illustrates a printing head with a rotating mechanism for changing nozzles, according to some embodiments;

FIG. 4 schematically illustrates a printing head with a rotation or translation mechanism for changing nozzles, according to some embodiments;

FIG. 5 is a flowchart depicting a method for planning printing by the three-dimensional printer shown in FIG. 1, according to some embodiments; and

FIG. 6 is a flowchart depicting a method for printing by the three-dimensional printer shown in FIG. 1, according to some embodiments.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, the conjunction “or” as used herein is to be understood as inclusive (any or all of the stated options).

In accordance with an embodiment of the invention, a three-dimensional printer includes a printing head that is configured to extrude a three-dimensional printing material solely through a selected nozzle of a plurality of selectable nozzles. The printing head includes a heater for fusing the material. The plurality of nozzles may differ from one another by the sizes or shapes of the openings through which the material is extrudable. A controller of the three-dimensional printer is configured to operate a mechanism for causing the fused material to be extruded solely through the opening of a selected nozzle of the plurality of nozzles. The selection may be based on a user selection, or may be automatically selected in accordance with predetermine criteria. Instructions for selection of a nozzle through which to print each part of the object may be encoded in the form of a printing plan, e.g., that was previously generated in accordance with a description of the object and capabilities of the three-dimensional printer.

Typically, in a three-dimensional printer such as a fused deposition modeling (FDM) printer, a printing head includes a heater for heating a printing material, typically a polymer, to at least a melting point of the material. For example, the printing material may be fed into the printing head in the form of a wire or filament of the material. In an embodiment of the invention, as the material enters the printing head, the material is melted and extruded via a selected nozzle of the plurality of nozzles.

For example, two or more nozzles with nozzle openings that vary in size, shape, or both may be mounted on a printing head. One or more techniques may be applied in order to select a nozzle through which the fused material is to be extruded. In some examples, a nozzle that is not currently selected for extrusion of the fused material may be heated. Such heating may enable immediate extrusion through a nozzle immediately after that nozzle is selected. The heating may also prevent material from solidifying within the nozzle or nozzle opening, and thus impeding extrusion of fused material when that nozzle is selected for extrusion again at a later time.

For example, multiple nozzles may be mounted on a wheel that is rotatable to move a selected nozzle to a conduit or opening through which the fused material flows outward. In one example, the nozzles may be mounted on the outer perimeter or rim of the wheel so as to extend radially outward from the rim of wheel. Rotating the wheel may bring a selected nozzle to the conduit. In another example, the nozzles may be arranged to extend axially outward from a face of the wheel, e.g., arranged in a circular pattern around the periphery of the wheel. The wheel may be rotated about it axis until a selected nozzle is brought to the conduit. In some embodiments, a printing head comprising such a wheel may be exchangeable, e.g., to a similar wheel with different and/or additional nozzle size or gauge.

As another example, nozzles may be arranged on the surface of a plate, e.g., extending approximately perpendicularly to the surface, that is translatable, rotatable, or both. The plate may be translated, rotated, or both to bring a selected nozzle to the conduit.

As another example, the printing head may include an enclosed reservoir of the fused material. Walls of the reservoir include a plurality of nozzles through which the fused material that is in the reservoir may be extruded. Each nozzle may be provided with a valve or plug that may be opened to allow extrusion via that nozzle, or closed to block extrusion via that nozzle.

As another example, a printing head may be configured to enable attachment of a nozzle, or detachment of the nozzle from the printing head. For example, a rack or other storage arrangement may be arranged at a region of the three-dimensional printer that is outside of a volume in which a three-dimensional object is printed. When it is necessary to change a nozzle, the printing head may be moved to a vacant region (e.g., slot or holder) of the storage arrangement. A detachment mechanism of the printing head may be operated to detach the currently attached nozzle from the printing head such that the detached nozzle is placed in the vacant region. The printing head may then be moved to a location of the storage arrangement where a nozzle that has been selected is for attachment to the printing head is stored. An attachment mechanism of the printing head may then be operated to attach the selected nozzle to the printing head. The printing head may then be moved to a location where material is to be extruded via the selected nozzle.

The printing head may include one or more other types of mechanisms for selection and attachment of a nozzle.

In some cases, each nozzle may be marked in a manner that enables or facilitates identification of a selected nozzle. For example, each nozzle may include markings that may be detected by an optical scanner. Such markings may include a one- or two-dimensional bar code, one or more alphanumeric characters, coloring, a pattern, or another type of marking. In some cases, a nozzle may include raised or indented markings that may be detected optically, electromagnetically, mechanically, or otherwise. Markings may include a radiofrequency identification (RFID) tag, or other electromagnetically identifiable marking. The printing head, or other structure of the three-dimensional printer, may include a sensor that is configured to detect the marking.

A controller of the three-dimensional printer may be configured to execute a three-dimensional printing method that includes selection and use of various nozzles during a three-dimensional printing operation. For example, a printing optimization program that produces detailed printing instructions for printing a particular three-dimensional object may be designed to select a nozzle that is appropriate for each step of the three-dimensional printing of the object.

For example, a three-dimensional model of the object to be printed may be input into a three-dimensional printing planning module or program. The model may include the shape of the object, as well as specifying such features as thickness of walls, type or density of infill, type of materials, or other features of the object to be printed.

A three-dimensional printing planning module or program may calculate a size, and, in some cases, shape, of a nozzle that is to be used to extrude fused material onto each region of the object as it is printed. For example, a nozzle with a larger opening may be selected as appropriate when printing a thicker wall, coarser feature or infill pattern, or other relatively large or coarse regions. On the other hand, a nozzle with a smaller opening may be selected for printing a thinner wall, a finer feature or infill pattern, or other relatively small or fine regions of the solid. The three-dimensional printing planning module or program may select the nozzle opening in accordance with predefined criteria. Such criteria may include size and shape of a feature to be printed, type of material or properties of a material (e.g., properties possibly including one or more of melting point, specific heat, viscosity, density, or other properties), required tolerances of a region of the object, or other criteria.

Optimization criteria may include minimizing a printing time, minimizing material usage, achieving a required material strength of the object, required smoothness or other surface properties of the printed object, or other optimization criteria. A printing optimization function of the three-dimensional printing planning program may be configured to achieve an optimal balance among various, and sometimes competing, optimization criteria. The optimal balance may, in some cases, be defined in terms of weighting factors for each criterion, e.g., based on user input or otherwise.

A printer control program may, at each point during three-dimensional printing of the object, direct a printing head operation mechanism to select a head that was designated by the three-dimensional printing planning program for printing each section of the object.

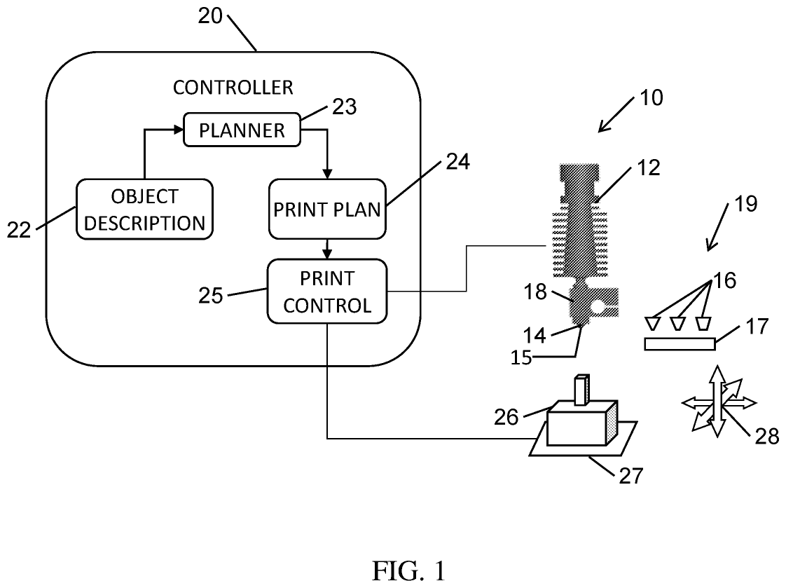

FIG. 1 schematically illustrates a three-dimensional printer with changeable nozzles, in accordance with an embodiment of the invention.

Three-dimensional printing system 10 includes a printing head 12. Printing head 12 includes fusing heater 18 that is configured to fuse a printing material (e.g., polymer, metal, ceramic, or other material) from which a selectable nozzle 16 is to be constructed by three-dimensional printing (additive manufacturing). For example, printing head 12 may include a reservoir of the printing material in a solidified form that may be fed into fusing heater 18 to be fused to a liquid form. The solidified form of the printing material may include a wire or filament, a powder, pellets, or another form.

The printing material that is fused by fusing heater 18 may be extruded via an attached nozzle 14 for deposition onto object base 27 or previously deposited layer of material. After extrusion of the printing material, the material may solidify by cooling (e.g., by heat transfer to the ambient atmosphere), may be caused to solidify by a curing agent (e.g., radiation or chemical agent), or may otherwise solidify. The solidified material may form a part of three-dimensional object 26.

For example, printing head 12, object base 27, or both, may be controllable by printer controller 20 to move relative to one another in three dimensions, as indicated by motion arrows 28. For example, printing head 12 may be translatable along a rail that is itself translatable in a direction that is perpendicular to the motion along the rail. Similarly, object base 27 may be mounted on a platform that is raisable toward printing head 12, or lowerable away from printing head 12 (e.g., to enable deposition of a layer of extruded material above a previously deposited layer). Alternatively or in addition, printing head 12, object base 27, or both are capable of being translated, rotated, or both in three dimensions, as indicated by motion arrows 28. Alternatively or in addition, printing head 12 may be mounted on an arm that is operated using delta robot technology so as to enable three-dimensional motion of printing head 12, as indicated by motion arrows 28.

The rate and distribution of the fused material that is extruded via attached nozzle 14 for depositing in forming three-dimensional object 26 may depend in part on the size and shape of nozzle opening 15 at a distal end of attached nozzle 14. For example, extrusion via a larger diameter or other characteristic dimension of nozzle opening 15 may result in a greater rate of outflow of the extruded material than extrusion via a nozzle opening 15 with a smaller diameter. Similarly, a shape of nozzle opening 15, e.g., circular, oval, polygonal, or otherwise shaped, may influence a distribution of the deposited material.

Three-dimensional printing system 10 includes a plurality of selectable nozzles 16, one of which may be attached to printing head 12 to function as attached nozzle 14. Typically, nozzle opening 15 of each selectable nozzle 16 differs from nozzle openings 15 of the other selectable nozzles 16. For example, the nozzle openings 15 of different selectable nozzles 16 may differ from one another in size, shape, or both.

Printer controller 20, or another device that is configured to plan three-dimensional printing by three-dimensional printing system 10, may be configured to determine which selectable nozzle 16 is to be used to print each section of three-dimensional object 26. The selection of a particular selectable nozzle 16 may be in accordance with predetermined criteria. Such criteria may include a size, shape, and tolerances of a detail or section of three-dimensional object 26 that is currently being printed, properties of the material being extruded (e.g., viscosity, density, specific heat, melting point, or other properties that may affect behavior of the material that is being extruded), ambient conditions (e.g., affecting a rate of solidification of the material), or other factors.

For example, object description 22, which includes a complete description of three-dimensional object 26, may be input into printing planning module 23 of printer controller 20 (or of another device or system). For example, object description 22 may be generated by a computer-aided design program, or otherwise. Object description 22 may include a complete three-dimensional description of the object or its surfaces. For example, the description may be expressed as coordinates, sizes, and orientation of three-dimensional building blocks of predetermined form, of surface elements of predetermined size or form, or both, or otherwise. The description may include a determination (e.g., based on engineering requirements that are input by a designer) of structural properties of three-dimensional object 26 (thicknesses of walls, infill type and density, materials, or other properties) that provide for required characteristics of three-dimensional object 26 (e.g., elasticity, flexibility, rigidity, heat capacity, weight, density, or other bulk properties; texture, color, resistance to exposure to corrosive materials or other potentially damaging environmental factors, or other surface properties; or other characteristics).

Printing planning module 23 may analyze object description 22 in view of characteristics of three-dimensional printing system 10 to generate a printing plan 24. For example, printing plan 24 may determine an ordered sequence of actions to be performed by three-dimensional printing system 10 in order to produce three-dimensional object 26 in accordance with object description 22. An action may include one or more of movement of one or both of printing head 12 and object base 27, selection of a selectable nozzle 16 to function as attached nozzle 14, extrusion (e.g., at a particular rate, for a particular period of time, or otherwise) of fused material via attached nozzle 14 at each relative location between printing head 12 and object base 27, selection of a material to be extruded (e.g., where three-dimensional printing system 10 enables changing of a printing material), or other types of actions.

For example, printing planning module 23 may be configured to generate printing plan 24 in accordance with predetermined criteria. The criteria may include global objectives (e.g., minimizing the time required for printing three-dimensional object 26, minimizing waste of materials, or other global objectives) as well as local objectives (e.g., accurate reproduction of surface or structural details of three-dimensional object 26 as described by object description 22, avoiding risk of a subsequent extrusion of material marring a previously deposited region of three-dimensional object 26, or other local objectives). A printing plan 24 that is generated by printing planning module 23 may include selection of a selectable nozzle 16 for each extrusion of fused material so as to satisfy these criteria and objectives.

Print control module 25 is configured to control one or more of movement of printing head 12, movement of object base 27, selection of a selectable nozzle 16, and extrusion of material via an attached nozzle 14, in accordance with instructions that are provided by printing plan 24.

In one example, selectable nozzles 16 may be arranged at one or more storage regions 19 within three-dimensional printing system 10 that are located within a range of motion of printing head 12, but are outside a printable area of object base 27 within which a three-dimensional object 26 may be printed. When attached nozzle 14 is to be replaced with a selectable nozzle 16, printing head 12 may be moved to a location where attached nozzle 14 may be removed from printing head 12 to become a selectable nozzle 16. For example, storage region 19 may include a plurality of nozzle holders that are each configured to hold a selectable nozzle 16. Thus, printing head 12 may be moved to a vacant nozzle holder at storage region 19, where a release mechanism of printing head 12 may be operated to detach attached nozzle 14 when attached nozzle 14 is placed into the vacant nozzle holder.

After attached nozzle 14 is detached from printing head 12, printing head 12 may be moved to a selected (in accordance with printing plan 24) selectable nozzle 16 in the same or a different storage region 19. An attachment mechanism of printing head 12 may be operated to attach the selected selectable nozzle 16 to printing head 12 to function as attached nozzle 14.

For example, an attachment mechanism may include one or more projections on printing head 12 that may be extended or manipulated to engage a cooperating indentation or slot of attached nozzle 14. In this example, a release mechanism may retract or otherwise manipulate each projection so as to remove it from the indentation or slot. In other examples, the attachment mechanism may include an electromagnet one printing head 12 which may be switched off to release attached nozzle 14. Other mechanisms are possible.

Storage region 19 may include one or more heating mechanisms 17 to maintain selectable nozzles 16 at an operating temperature when stored. Maintaining selectable nozzles 16 at an operating temperature may enable immediate extrusion via a newly attached nozzle 14. In addition, maintaining selectable nozzles 16 at the operating temperature may prevent solidification of material within nozzle openings 15, thus preventing clogging of nozzle opening 15 or imprecise extrusion of fused material via that nozzle opening 15.

For example, heating mechanism 17 may include a conductive heater that is in contact with selectable nozzles 16 in storage region 19, a radiator that radiates heat toward selectable nozzles 16, or a convective heater that heats selectable nozzles 16 via convection. Alternatively or in addition, heating mechanism may be configured to pass an electrical current through each selectable nozzle 16 so as to heat that selectable nozzle 16 by resistive heading. Other heating mechanisms may be used.

Alternatively or in addition, other mechanisms may be used to select a selectable nozzle 16.

In some examples, a printing head may be provided with a nozzle selection mechanism.

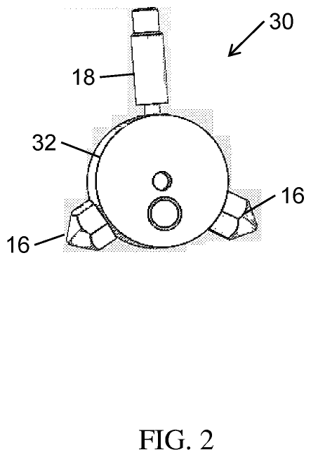

FIG. 2 schematically illustrates an example of a printing head with selectable nozzles.

In printing head 30, printing material that is fused by fusing heater 18 flows into reservoir 32. In the example shown, printing head 30 includes two selectable nozzles 16. In other examples, printing head 30 may include three or more selectable nozzles 16.

Reservoir 32 may include a mechanism for directing fused material into a selected selectable nozzle 16 of selectable nozzles 16 for extrusion via the selected nozzle. The mechanism may prevent outflow of the fused material via any of selectable nozzles 16 other than the selected nozzle.

For example, a mechanism for directing outflow of the fused material through a selected selectable nozzle 16 may include a rotatable conduit internal to printing head 30. In another example, each selectable nozzle 16 of printing head 30 may be provided with a stopper and an operating mechanism that may open a selected nozzle while closing the other selectable nozzles 16.

In some cases, printing head 30 may be manipulable (e.g., by rotation or tilting) such that the selected nozzle is oriented relative to three-dimensional object 26 so as to deposit the fused material in a required manner and location.

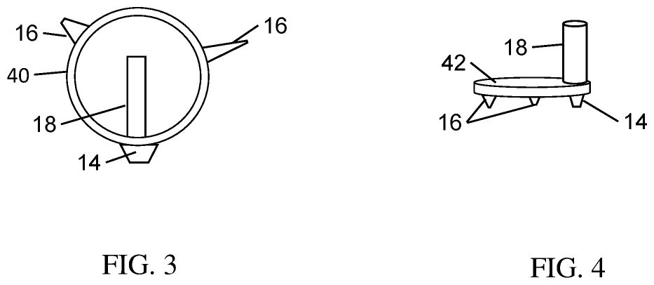

FIG. 3 schematically illustrates a printing head with a rotating mechanism for changing nozzles.

In the example shown, nozzle ring 40 includes a plurality of selectable nozzles 16 that extend radially outward. Rotation of nozzle ring 40 about its axis may bring one of selectable nozzles 16 to the location of fusing heater 18. The selectable nozzle 16 that is positioned at fusing heater 18 functions as an attached nozzle 14, such that fused material that is fused by fusing heater 18 may be extruded outward via attached nozzle 14.

In the example shown, nozzle ring 40 rotates about an axis that is perpendicular to a direction in which fused material is extruded from fusing heater 18. In other examples, a nozzle ring may be rotated about an axis that is parallel to the direction of extrusion (e.g., that is parallel to the plane of the figure, and displaced from fusing heater 18 by a distance that is approximately equal to the radius of the nozzle ring). In another example, the nozzle ring may be oriented at an oblique angle to the direction of extrusion. In this other example, selectable nozzles 16 may extend from the nozzle ring in a non-radial direction.

In the example shown, nozzle ring 40 is circular. In other examples, nozzle ring 40 may have an oval, polygonal, or other shape.

FIG. 4 schematically illustrates a printing head with a rotation or translation mechanism for changing nozzles.

In the example shown, nozzle plate 42 includes a plurality of selectable nozzles 16 that extend outward from a face of nozzle plate 42, e.g., approximately perpendicularly to the face. Rotation of nozzle plate 42 about an axis, translation of nozzle plate 42 in a plane that is parallel to the face from which selectable nozzles 16 extend, or both rotation and translation, may bring one of selectable nozzles 16 to the location of fusing heater 18. The selectable nozzle 16 that is positioned at fusing heater 18 functions as an attached nozzle 14, such that fused material that is fused by fusing heater 18 may be extruded outward via attached nozzle 14.

For example, selectable nozzles 16 may be arranged in a circular pattern, in a rectangular array, in a pattern of concentric circles, in a spiral pattern, or otherwise on a face of nozzle plate 42. In the example shown, nozzle plate 42 is circular. In other examples, nozzle plate 42 may have an oval, polygonal, or other shape. In the example shown, nozzle plate 42 has a planar face. In other examples, a face of nozzle plate 42 may be concave or convex (e.g., with each selectable nozzle 16 extending perpendicularly outward from a local tangent to the face).

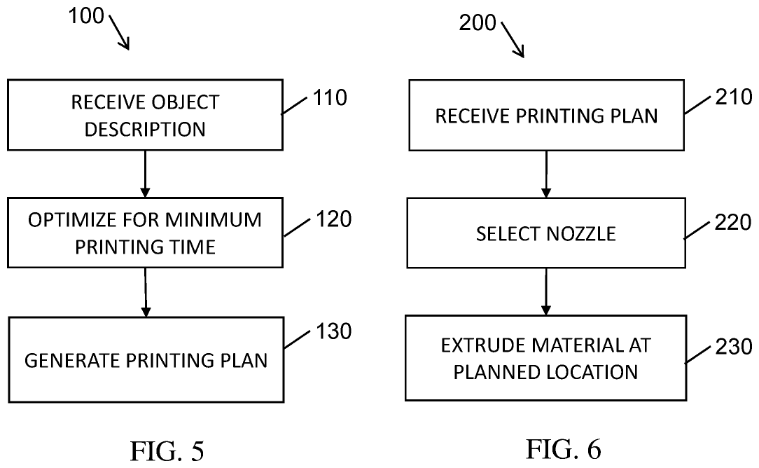

FIG. 5 is a flowchart depicting a method for planning printing by the three-dimensional printer shown in FIG. 1.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Printing planning method 100 may be executed by a processor, e.g., in response to input of an object description. For example printing planning method 100 may be executed by printing planning module 23 of printer controller 20 of three-dimensional printing system 10, or by another processor that is programmed to execute printing planning method 100.

A processor that is executing printing planning method 100 may receive an object description 22 (block 110), e.g., as input by a user (via a communications channel or via a computer readable medium), or that may be generated by a suitable computer aided design or other program. The format of object description 22 may include a stereolithographic model (STL) or other format. Typically, object description 22 includes structural details such as wall thickness, infill type and density, surface texture, or other details.

Printing planning module 23 may calculate an optimized sequence of actions by three-dimensional printing system 10 so as to generate a three-dimensional object 26 that is described by object description 22 within a minimal amount of time (block 120). Typically, sequence of actions includes generating relative motion between printing head 12 and object base 27 such that printing head 12 is positioned for deposition of fused material to form a part of three-dimensional object 26. The actions further include selection of a selectable nozzle 16 for depositing fused material to print each part of three-dimensional object 26. The calculation may employ one or more optimization techniques known in the art in order to achieve an optimized sequence of actions.

Printing planning module 23 may generate a printing plan 24 that includes a list of instructions for executing the calculated optimized sequence of actions by three-dimensional printing system 10 (block 130). The printing plan may be stored in a data storage device of printer controller 20, on a computer readable medium, remotely, or elsewhere. In some cases, printer controller 20 may be configured to execute printing plan 24 upon generation of printing plan 24.

FIG. 6 is a flowchart depicting a method for printing by the three-dimensional printer shown in FIG. 1.

Printing method 200 may be executed by a printer controller 20 of three-dimensional printing system 10, e.g., in response to a received command to print a three-dimensional object 26. For example printing method 200 may be executed by print control module 25 of printer controller 20.

A printing plan 24 may be received (block 210), e.g., from a data storage device of printer controller 20, or that is input by a user of three-dimensional printing system 10, e.g., via a data channel or via a computer readable medium. Printer controller 20 may then operate one or both of printing head 12 and object base 27 in accordance with the received printing plan 24 in order to cause printing of three-dimensional object 26.

At each stage of printing of three-dimensional object 26, a selectable nozzle 16 may be selected for deposition of fused material at each stage of operation (block 220). In some cases, a previously selected attached nozzle 14 may continue to be used. In other cases, one or more techniques, as described above, may be implemented to select a different selectable nozzle 16.

When the selected nozzle is in condition for extrusion of fused material, the fused material may be extruded via the selected attached nozzle 14 at a location as indicated by printing plan 24 (block 230). The operations indicated by blocks 220 and 230 may be repeated until printing of three-dimensional object 26 is complete.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A three-dimensional printer comprising:
a printing head that includes a heater for fusing a material;
a plurality of nozzles, each nozzle including an opening through which the material that is fused by the heater is extrudable; and
a nozzle selection mechanism for causing the fused material to be extruded solely through the opening of a selected nozzle of the plurality of nozzles.

2. The printer of claim 1, wherein the opening of a nozzle of the plurality of nozzles differs in size or shape from the opening of another nozzle of the plurality of nozzles.

3. (canceled)

4. The printer of claim 1, wherein the printer comprises a storage region in which the plurality of nozzles are storable.

5. The printer of claim 4, wherein the nozzle selection mechanism comprises a moving mechanism to move the printing head to a storage location of the selected nozzle within the storage region to attach the selected nozzle to the printing head.

6. The printer of claim 5, wherein the moving mechanism is further configured to move the printing head to a vacant storage location within the storage region to store a currently attached nozzle after detachment from the printing head.

7. The printer of claim 3, wherein the nozzle selection mechanism comprises a ring, and wherein the plurality of nozzles are mounted on the ring that is rotatable to bring the selected nozzle to the heater to enable extrusion of the fused material through the opening of the selected nozzle.

8. The printer of claim 7, wherein the nozzle selection mechanism is configured to rotate the ring.

9. The printer of claim 3, wherein the nozzle selection mechanism comprises a plate, and wherein the plurality of nozzles are mounted on the plate that is movable to bring the selected nozzle to the heater to enable extrusion of the fused material through the opening of the selected nozzle.

10. The printer of claim 9, wherein the nozzle selection mechanism is configured to rotate or translate the plate.

11. The printer of claim 1, wherein the printing head further comprises a reservoir of the fused material to which the plurality of nozzles are attached, wherein each of the nozzles includes a stopper.

12. The printer of claim 11, wherein the nozzle selection mechanism is configured to open the stopper of the selected nozzle, while closing the stopper of all other nozzles of the plurality of nozzles.

13. The printer of claim 1, comprising a controller that is configured to operate the nozzle selection mechanism in accordance with a previously generated printing plan.

14. A method for generating a printing plan for operation of a three-dimensional printer to print a three-dimensional object, the method comprising:
receiving a description of the object;
calculating a sequence of actions to be performed by the printer that optimizes printing of the object, the actions including at least:
selecting a nozzle of a plurality of nozzles; and
extruding material that is fused by a heater of the printing head through the selected nozzle to print a part of the object.

15. The method of claim 14, wherein said optimizing of said printing plan comprises at least one of: minimizing a printing time, minimizing material usage, achieving a required material strength of the object, and achieving a required surface property of the object.

16. The method of claim 14, wherein the opening of a nozzle of the plurality of nozzles differs in size or shape from the opening of another nozzle of the plurality of nozzles.

17. The method of claim 14, wherein the selected nozzle is attachable to the printing head to enable extrusion of the fused material through the opening of the selected nozzle, and is detachable from the printing head after the extrusion through the selected nozzle.

18. The method of claim 17, wherein the printer comprises a storage region in which the plurality of nozzles are storable.

19. (canceled)

20. (canceled)

21. The method of claim 17, wherein the plurality of nozzles are mounted on a ring that is rotatable to bring the selected nozzle to the heater to enable extrusion of the fused material through the opening of the selected nozzle.

22. (canceled)

23. The method of claim 17, wherein the plurality of nozzles are mounted on a plate that is movable to bring the selected nozzle to the heater to enable extrusion of the fused material through the opening of the selected nozzle.

24. The method of claim 23, wherein the mechanism is configured to rotate or translate the plate.

25.-27. (canceled)
